(19) United States
(12) Patent Application Publication
(10) Pub. No.: US 2010/0112419 A1
(43) Pub. Date: May 6, 2010

(54) BATTERY TEMPERATURE CONTROLLER FOR ELECTRIC VEHICLE USING THERMOELECTRIC SEMICONDUCTOR

(76) Inventors: Soo Yeup Jang, Daejeon (KR); Joong Hui Lee, Daejeon (KR)

Correspondence Address: GOTTLIEB RACKMAN & REISMAN PC, 270 MADISON AVENUE, 8TH FLOOR, NEW YORK, NY, 10016-0601, US

(21) Appl. No.: 12/532,277

(22) PCT Filed: Mar. 20, 2008
(86) PCT No.: PCT/KR2008/001575

§ 371 Date: Sep. 21, 2009

(30) Foreign Application Priority Data
Apr. 4, 2007 (KR) 1020070033321

(51) Int. Cl. H01M 10/50

(52) U.S. Cl. 429/62

(57) ABSTRACT

Disclosed herein is a device for controlling the temperature of batteries for electric vehicles. The device includes a thermoelectric semiconductor unit, a thermoelectric semiconductor unit, a temperature sensor, and a battery controller. The thermoelectric semiconductor unit is configured such that a portion thereof is exposed in a battery tray. The thermoelectric semiconductor unit controller causes the thermoelectric semiconductor unit to radiate heat, and causes the thermoelectric semiconductor unit to absorb heat. The temperature sensor detects and outputs the temperature of the battery tray. The battery controller outputs the heat radiating control signal to the thermoelectric semiconductor unit controller when the temperature detected by the temperature sensor is lower than a predetermined value, and outputting the heat absorbing control signal to the thermoelectric semiconductor unit controller when the temperature detected by the temperature is equal to or higher than the predetermined value.

### TECHNICAL FIELD

The present invention relates to a device for controlling the temperature of batteries for electric vehicles (including hybrid vehicles).

More particularly, the present invention relates to a device for controlling the temperature of batteries for electric vehicles, which can cool batteries, which are mounted in an electric vehicle, using thermoelectric semiconductor elements.

### BACKGROUND ART

Generally, vehicles are classified into steam vehicles, internal combustion engine vehicles, and electric vehicles according to the type of power source. Of the vehicles, the electric vehicle is currently attracting more attention as a means for solving the problem of serious atmospheric pollution due to the exhaust gas of internal combustion engine vehicles and the problem of increased fuel expenses due to the high price of oil.

Such an electric vehicle is a device that uses electricity as its power source, and is moved by operating an electric motor using electrical energy, unlike a general vehicle, which moves using the energy that is obtained by burning petroleum-based fuel in an internal combustion engine.

Furthermore, the electric vehicle generates hardly any noise or vibrations, and does not discharge any exhaust gas, so that it does not cause any smell and does not pollute the atmosphere.

The electric vehicle is designed to be moved based on the principle of driving wheels by rotating an electric motor using electrical energy. Battery energy having a high-voltage characteristic is necessarily required in order to move the vehicle.

However, currently, a high battery energy, which is sufficient to operate an electric vehicle, cannot be realized using only a single battery, and thus a plurality of batteries must be connected in series or in parallel not only to realize a high voltage but also to maintain a long lifespan.

An entity in which a plurality of batteries is aggregated and held is called a battery pack. In practice, the battery pack is fastened to a tray having a box shape, and is then mounted in an electric vehicle.

The performance and lifespan of the above-described batteries are maintained by appropriately radiating the high heat that is generated upon operation. For example, the batteries are cooled using air inside or outside a vehicle. When air inside or outside a vehicle is used as described above, a delay occurs until the temperature of the batteries reaches a required appropriate temperature because air outside the vehicle can be anywhere within wide temperature and humidity ranges. Accordingly, a problem occurs in that the performance of the batteries is lowered until the temperature of the batteries falls within a normal temperature range.

FIG. 1 is a diagram showing the construction of a prior art battery cooling device.

Referring to FIG. 1, the battery cooling device includes a plurality of batteries 1, which are mounted in a battery tray 2 and are spaced apart from each other at regular intervals, the battery tray 2, which is configured such that the plurality of batteries 1 is mounted therein, and a cooling fan 3, which is configured to discharge heat, which is radiated from the batteries 1, at one side of the battery tray 2.

In the above-described battery cooling device, the cooling fan 3 is mounted in the battery tray 2, in which the plurality of batteries 1 is mounted, and an auxiliary battery 4 is connected to the cooling fan 3 via a starting switch 5 and a battery controller 6.

Furthermore, a temperature sensor 7 is mounted in the battery tray 2. A relay is provided in the battery controller 6, and is configured to be controlled in response to a detection signal from the temperature sensor 7 and to interrupt the supply of power to the cooling fan 3 or supply the power to the cooling fan 3.

The prior art cooling device, described above, causes the battery controller 6 to maintain an appropriate temperature according to the detection signal from the temperature sensor 7 when the starting switch 5 is merely turned on, and can control an increase in the temperature of the batteries at room temperature to some extent. However, the prior art cooling device cannot actively response to variations in the temperature conditions outside a vehicle, that is, low or high temperature conditions. This is a major cause of reduction in the performance of the batteries.

In order to solve the above-described problems occurring in the prior art, a method of supplying the exhaust gas of a vehicle, or cool air, which is obtained through heat exchange in an air-conditioner, to batteries is used. However, this method not only makes the device complicated but also makes it difficult to control, and thus the manufacturing cost of each vehicle is increased.

Furthermore, there is a method of thermally connecting a heat sink and the electrodes of batteries to each other and heating or cooling the heat sink. However, this method is problematic in that it is difficult to select and use the medium that is used to heat or cool the heat sink and in that a separate heat source must be provided.

Based on semiconductor cooling and heating elements, there is a method of attaching thermoelectric cooling elements to the respective outer surfaces of batteries and performing heating and cooling using separate heat transfer media. In this case, there is a problem in that the heat generated in high-capacity electric vehicle batteries cannot be cooled to an appropriate temperature due to the amount of heat energy that is transmitted to the batteries, depending on the transfer media, and due to a transfer time delay. Furthermore, the main body casing of each battery is generally made of thick plastic material, rather than metal, so that individual batteries cannot be effectively cooled due to the low thermal conductivity thereof, even if the main body casing is cooled. In the thermoelectric semiconductor elements, the outer surface thereof performs a heat radiating operation while a cooling surface is formed therein to perform a cooling operation. In the case where the operations are performed in reverse, reverse conditions are established. In the prior art, there is no cooling device for protecting semiconductor elements from the heat that is generated at the time of reversible reaction of elements, so that a problem occurs in that the elements are overheated and damaged upon practical application.

Unlike a general battery, such as a lead acid battery, an electric vehicle high-voltage battery provides a high voltage using a combination of a plurality of individual batteries. In the case where cooling is achieved through rapid heat transfer in this process, and the batteries are place at a low temperature, means for directly cooling and heating the individual batteries is required in order for the batteries to realize normal performance when rapidly heating. However, this problem cannot be solved using a method of cooling and heating the outer surface of a battery package.

### DISCLOSURE

### Technical Problem

Accordingly, the present invention has been made keeping in mind the above problems occurring in the prior art, and an object of the present invention is to provide a device for controlling the temperature of batteries for electric vehicles using thermoelectric semiconductor elements, which enables the temperature of batteries to be maintained at an appropriate level using thermoelectric semiconductor elements.

### Technical Solution

In order to solve the above-described problems, the present invention provides a device for controlling the temperature of batteries for electric vehicles, including: a thermoelectric semiconductor unit configured such that a portion thereof is exposed in a battery tray, thus radiating heat into a battery tray when input current flows in a first direction and absorbing heat inside the battery tray when the input current flows in a second direction; a thermoelectric semiconductor unit controller for causing the thermoelectric semiconductor unit to radiate heat by supplying the current, which flows in the first direction, to the thermoelectric semiconductor unit when a heat radiating control signal is input thereto, and causing the thermoelectric semiconductor unit to absorb heat by supplying the current, which flows in the second direction, to the thermoelectric semiconductor unit when a heat absorbing control signal is input thereto; a temperature sensor for detecting and outputting the temperature of the battery tray; and a battery controller for outputting the heat radiating control signal to the thermoelectric semiconductor unit controller when the temperature detected by the temperature sensor is lower than a predetermined value, and outputting the heat absorbing control signal to the thermoelectric semiconductor unit controller when the temperature detected by the temperature is equal to or higher than the predetermined value.

### Advantageous Effects

The optimal temperature of the batteries is satisfied by automatically control the ON/OFF operation of the thermoelectric semiconductor elements and the direction of current according to conditions of use of the batteries, so that the batteries can realize their optimal performance.

Furthermore, according to the present invention, semiconductor cooling elements are used as a heat source for cooling and heating, so that noise and vibrations, which are generated by the prior art cooling device using a vehicle air-conditioner or heater or using a fan, can be reduced.

Furthermore, according to the present invention, the heat radiating operation and the heat absorbing operation can be controlled using a single thermoelectric semiconductor element, so that the temperature control device can be easily implemented.

Furthermore, according to the present invention, the heat insulating material, which surrounds the batteries, the inlet three-way valve, and the outlet three-way valve isolate the battery unit from the external air, so that the batteries can be protected from variation in the external temperature even when a vehicle is not traveling.

Furthermore, according to the present invention, the temperature of the battery unit can be more effectively, rapidly and accurately controlled when the temperature of the external air, having a wide temperature range and a large volume, is controlled according to the cooling flow that is formed in order of the heat insulating material, which surrounds the batteries, the inlet three-way valve, the outlet three-way valve and the thermoelectric semiconductor unit.

### DESCRIPTION OF DRAWINGS

FIG. 1 is a diagram showing the construction of a prior art battery cooling device;

FIG. 2 is a diagram showing the construction of a device for controlling the temperature of batteries for electric vehicles using thermoelectric semiconductor elements according to an embodiment of the present invention;

FIG. 3 is a diagram showing the construction of a device for controlling the temperature of batteries for electric vehicles using thermoelectric semiconductor elements according to another embodiment of the present invention; and

FIG. 4 is a diagram showing the internal construction of the thermoelectric semiconductor unit of FIGS. 2 and 3.

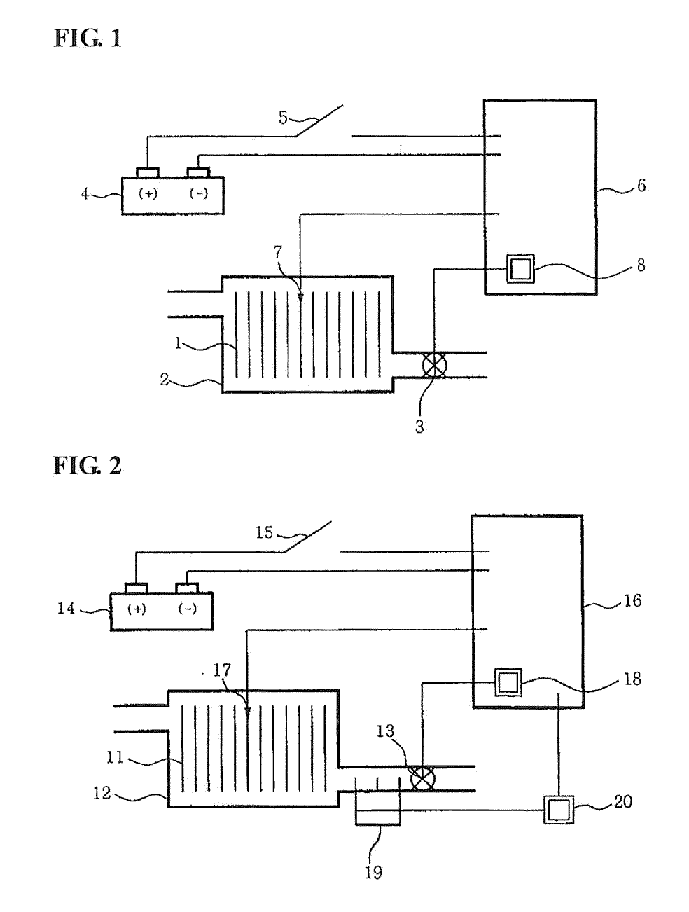

### DESCRIPTION OF REFERENCE NUMERALS OF PRINCIPLE ELEMENTS

11: battery
12: battery tray
13: cooling fan
14: auxiliary battery
15: switch
16: battery controller
17: temperature sensor
18: relay
19: thermoelectric semiconductor unit
20: thermoelectric semiconductor unit controller
21: thermoelectric semiconductor elements
22: heat radiating fins
23: control wire
30: inlet three-way valve
31: outlet three-way valve
32: heat insulating material
33: recirculation air pipe

### BEST MODE

A device for controlling the temperature of batteries for electric vehicles using thermoelectric semiconductor elements according to a preferred embodiment of the present invention is described in detail with reference to FIG. 2 below.

FIG. 2 is a diagram showing the construction of the device for controlling the temperature of batteries for electric vehicles using thermoelectric semiconductor elements according to an embodiment of the present invention.

Referring to FIG. 2, the device for controlling the temperature of batteries for electric vehicles using thermoelectric semiconductor elements according to an embodiment of the present invention includes a plurality of batteries 11, a battery tray 12, a cooling fan 13, an auxiliary battery 14, a starting switch 15, a battery controller 16, a temperature sensor 17, a relay 18, a thermoelectric semiconductor unit 19, and a thermoelectric semiconductor unit controller 20.

The battery tray 12 is formed to have a hollow shape and, for example, is mounted on the bottom of an electric vehicle while containing the plurality of batteries 11 therein. This battery tray 12 is not limited thereto, and, for example, may be mounted in the front or rear portion or a vehicle.

The cooling fan 13 is located in the exhaust port of the battery tray 12, and discharges heat, which is radiated from the batteries 11, by sucking and discharging air inside the battery tray 12.

The above-described cooling fan 13 is connected to the auxiliary battery 14 so that the heat, which is radiated from the batteries 11, can be discharged to the outside via the starting switch 15 and the battery controller 16.

The auxiliary battery 14 is used to supply low power to parts other than parts that are supplied with power from the batteries 11, and is mounted outside the battery tray 12.

Furthermore, the battery controller 16 causes power to be supplied to the cooling fan 13 or the thermoelectric semiconductor unit 19 by operating the relay 18 according to the temperature in the battery tray 12.

The temperature sensor 17 is mounted in the battery tray 12, and detects and outputs the temperature in the battery tray 12.

The temperature sensor 17 transmits the detected temperature in the battery tray 12 to the battery controller 16.

Furthermore, the battery controller 16 is configured to supply power to the cooling fan 13 and the thermoelectric semiconductor unit 19, or to interrupt the supply of the power thereto, by controlling the operation of the relay 18 in response to the detection signal of the temperature sensor 17.

Meanwhile, as shown in FIG. 4, the thermoelectric semiconductor unit 19 is located between the cooling fan 13 and the batteries 11, and is provided with thermoelectric semiconductor elements 21 and heat radiating fins 22.

Each of the thermoelectric semiconductor elements 21 has a structure in which two metals having different properties from each other are bonded to each other, and performs a heat radiating operation or a heat absorbing operation according to the direction of current (which is called the Peltier effect). The heat radiating or absorbing operation causes heat to be transmitted to the battery tray 12 via the heat radiating fins 22.

The heat radiating fins 22 function to transmit heat to the battery tray 12 when the thermoelectric semiconductor elements 21 perform the heat radiating operation or the heat absorbing operation, and are configured such that the first ends thereof are attached to the thermoelectric semiconductor elements 21 and such that the second ends thereof are exposed into the exhaust port of the battery tray 11.

Furthermore, the thermoelectric semiconductor unit controller 20 is located between the thermoelectric semiconductor elements 21 and the battery controller 16, and supplies current to the themioelectric semiconductor elements 21 under the control of the battery controller 16.

In this case, it is necessary for the thermoelectric semiconductor unit controller 20 to control the direction of the current that is transmitted to the thermoelectric semiconductor elements 21. The reason for this is because the thermoelectric semiconductor elements 21 perform the heat radiating or absorbing operation according to the direction of the flowing current.

Meanwhile, the thermoelectric semiconductor unit controller 20 and the thermoelectric semiconductor elements 21 are connected to each other using control wires 23.

The above-described temperature control device according to the present invention enables the battery controller 16 to maintain an appropriate temperature in response to the detection signal from the temperature sensor 17 when the starting switch 15 is merely turned on.

That is, the battery controller 16 receives the detected temperature from the temperature sensor 17, which is located in the battery tray 12.

Furthermore, if it is determined that the temperature received from the temperature sensor 17 is equal to or greater than a predetermined temperature, the battery controller 16 causes heat to be radiated by sequentially operating the relay 18 and the cooling fan 13.

The battery controller 16 transmits a control signal to the thermoelectric semiconductor unit controller 20, thus causing the heat absorbing operation to be performed by causing the thermoelectric semiconductor unit controller 20 to supply current to the thermoelectric semiconductor elements 21. Subsequently, the heat radiating fins 22 transfer the heat in the battery tray 11 to the thermoelectric semiconductor elements 21 thanks to the heat absorbing operation of the thermoelectric semiconductor elements 21, thus reducing the temperature of the battery tray 11.

Meanwhile, if it is determined that the temperature received from the temperature sensor 17 is lower than the predetermined temperature, the battery controller 16 transmits a control signal to the thermoelectric semiconductor unit controller 20, thus causing the heat radiating operation to be performed by causing the thermoelectric semiconductor unit controller 200 to supply current to the thermoelectric semiconductor elements 21. Subsequently, the heat radiating fins 22 transmit the heat of the thermoelectric semiconductor elements 21 to the battery tray 11 thanks to the heat radiating operation of the thermoelectric semiconductor elements 11, thus increasing the temperature in the battery tray 11.

Meanwhile, a combination of the thermoelectric semiconductor elements and the cooling fan has been described herein, but a combination of the thermoelectric semiconductor elements and a heater may be made.

### Mode for Invention

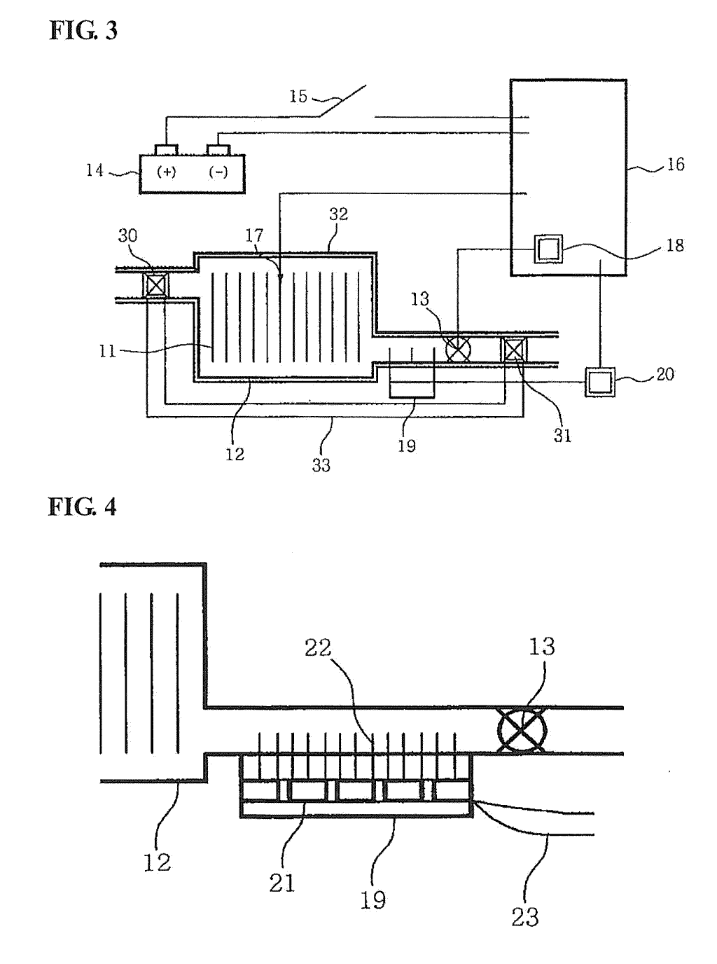

Meanwhile, a device for controlling the temperature of batteries for electric vehicles using thermoelectric semiconductor elements according to another embodiment of the present invention is described in detail with reference to FIG. 3 below.

FIG. 3 is a diagram showing the construction of the device for controlling the temperature of batteries for electric vehicles using thermoelectric semiconductor elements according to another embodiment of the present invention.

Referring to FIG. 3, the device for controlling the temperature of batteries for electric vehicles using thermoelectric semiconductor elements according to the embodiment of the present invention includes a plurality of batteries 11, a battery tray 12, a cooling fan 13, an auxiliary battery 14, a starting switch 15, a battery controller 16, a temperature sensor 17, a relay 18, a thermoelectric semiconductor unit 19, a thermoelectric semiconductor unit controller 20, an inlet three-way valve 30, an outlet three-way valve 31, a heat insulating material 32, and a recirculation air pipe 33.

The battery tray 12 is formed to have a hollow shape and, for example, is mounted on the bottom of an electric vehicle and contains the plurality of batteries 11 therein. The battery tray 12 is not limited thereto, and, for example, may be mounted in the front or rear portion or a vehicle.

The cooling fan 13 is located in the intake or exhaust port of the battery tray 12, and discharges heat, which is radiated from the batteries 11, by sucking and discharging the air inside the battery tray 12, or forcibly blowing air outside the vehicle into the battery tray 12.

The above-described cooling fan 13 is connected to the auxiliary battery 14 so that the heat radiated from the batteries 11 can be discharged to the outside via the starting switch 15 and the battery controller 16.

Furthermore, the inlet three-way valve 30 is used to change the direction of inlet air or to isolate the air inside the battery tray 12 and the air outside the battery tray 12 from each other, and is located in the intake port of the battery tray 12.

Furthermore, the outlet three-way valve 31 is used to change the direction of outlet air or to isolate the air inside the battery tray 12 and the air outside the battery tray 12 from each other, and is located in the exhaust port of the battery tray 12.

Furthermore, the heat insulating material 32 is located outside the battery tray 12, so that the outer portion of the battery tray 12 can be thermally insulated.

The recirculation air pipe 33 is used as a circulation path for recirculating air inside the battery tray 12, and is configured such that the inlet port thereof is connected to the inlet three-way valve 30 and such that the outlet port thereof is connected to the outlet three-way valve 31.

The inlet three-way valve 30 and the outlet three-way valve 31, described above, isolate the air inside the battery tray 12 and the air outside the battery tray 12 from each other in the state in which a vehicle system is not operated, by which the batteries 11 are little affected by the external temperature when a vehicle is exposed to low temperatures or high temperatures.

Furthermore, the recirculation air pipe 33 enables the heat, which is generated due to the use of the batteries 11 while the vehicle is traveling, to be recirculated in the battery tray 12 via the outlet three-way valve 31-recirculation air pipe 33-inlet three-way valve 31-batteries 11-cooling fan 13-thermoelectric semiconductor unit 19 of the battery tray 12. Accordingly, the heat inside a battery unit, which is generated while the vehicle is traveling, is cooled by the thermoelectric semiconductor unit and is rapidly supplied again, and thus air recirculation can be achieved such that the batteries can be used in a normal temperature range.

In this case, it is determined by the battery controller 16 whether it is necessary to suck the external air or to discharge the internal air through the switching operation of the inlet three-way valves 30 or the outlet three-way valve 31.

The auxiliary battery 14 is used to supply low power to parts other than parts that are supplied with power from the batteries 11, and is mounted outside the battery tray 12.

Furthermore, the battery controller 16 causes power to be supplied to the cooling fan 13 or the thermoelectric semiconductor unit 19 by operating the relay 18 according to the temperature in the battery tray 12.

The temperature sensor 17 is mounted in the battery tray 12, and detects and outputs the temperature in the battery tray 12.

The temperature sensor 17 transmits the detected temperature in the battery tray 12 to the battery controller 16.

Furthermore, the battery controller 16 is configured to supply power to the cooling fan 13 and the thermoelectric semiconductor unit 19, or to interrupt the supply of the power thereto, by controlling the operation of the relay 18 in response to the detection signal of the temperature sensor 17.

Meanwhile, as shown in FIG. 4, the thermoelectric semiconductor unit 19 is located between the cooling fan 13 and the batteries 11, and is provided with thermoelectric semiconductor elements 21 and heat radiating fins 22.

Each of the thermoelectric semiconductor elements 21 has a structure in which two metals having different properties from each other are bonded to each other, and performs a heat radiating operation or a heat absorbing operation according to the direction of current (which is called the Peltier effect). The heat radiating or absorbing operation causes heat to be transmitted to the battery tray 12 via the heat radiating fins 22.

The heat radiating fins 22 function to transmit heat to the battery tray 12 when the thermoelectric semiconductor elements 21 perform the heat radiating operation or the heat absorbing operation, and are configured such that the first ends thereof are attached to the thermoelectric semiconductor elements 21 and such that the second ends thereof are exposed in the exhaust port of the battery tray 11.

Furthermore, the thermoelectric semiconductor unit controller 20 is located between the thermoelectric semiconductor elements 21 and the battery controller 16, and supplies current to the thermoelectric semiconductor elements 21 under the control of the battery controller 16.

In this case, it is necessary for the thermoelectric semiconductor unit controller 20 to control the direction of the current that is transmitted to the thermoelectric semiconductor elements 21. The reason for this is because the thermoelectric semiconductor elements 21 perform the heat radiating or absorbing operation according to the direction of the flowing current.

Meanwhile, the thermoelectric semiconductor unit controller 20 and the thermoelectric semiconductor elements 21 are connected to each other using control wires 23.

The above-described temperature control device according to the present invention enables the battery controller 16 to maintain an appropriate temperature in response to the detection signal from the temperature sensor 17 when the starting switch 15 is merely turned on.

That is, the battery controller 16 receives the detected temperature from the temperature sensor 17, which is located in the battery tray 12.

Furthermore, if it is determined that the temperature received from the temperature sensor 17 is equal to or higher than a predetermined temperature, the battery controller 16 causes heat to be radiated by sequentially operating the relay 18 and the cooling fan 13.

The battery controller 16 transmits a control signal to the thermoelectric semiconductor unit controller 20, thus causing the heat absorbing operation to be performed by causing the thermoelectric semiconductor unit controller 20 to supply current to the thermoelectric semiconductor elements 21. Subsequently, the heat radiating fins 22 transfer heat in the battery tray 11 to the thermoelectric semiconductor elements 21 thanks to the heat absorbing operation of the thermoelectric semiconductor elements 21, thus reducing the temperature of the battery tray 11.

Meanwhile, if it is determined that the temperature received from the temperature sensor 17 is lower than the predetermined temperature, the battery controller 16 transmits a control signal to the thermoelectric semiconductor unit controller 20, thus causing the heat radiating operation to be performed by causing the thermoelectric semiconductor unit controller 200 to supply current to the thermoelectric semiconductor elements 21. Subsequently, the heat radiating fins 22 transmit the heat of thermoelectric semiconductor elements 21 to the battery tray 11 thanks to the heat radiating operation of the thermoelectric semiconductor elements 11, thus increasing the temperature of the battery tray 11.

Meanwhile, a combination of the thermoelectric semiconductor elements and the cooling fan has been described herein, but a combination of the thermoelectric semiconductor elements and a heater may be made.

1. A device for controlling a temperature of batteries for electric vehicles, comprising:
a thermoelectric semiconductor unit configured such that a portion thereof is exposed in a battery tray, thus radiating heat into a battery tray when input current flows in a first direction and absorbing heat inside the battery tray when the input current flows in a second direction;
a thermoelectric semiconductor unit controller for causing the thermoelectric semiconductor unit to radiate heat by supplying the current, which flows in the first direction, to the thermoelectric semiconductor unit when a heat radiating control signal is input thereto, and causing the thermoelectric semiconductor unit to absorb heat by supplying the current, which flows in the second direction, to the thermoelectric semiconductor unit when a heat absorbing control signal is input thereto;
a temperature sensor for detecting and outputting a temperature of the battery tray; and
a battery controller for outputting the heat radiating control signal to the thermoelectric semiconductor unit controller when a temperature detected by the temperature sensor is lower than a predetermined value, and outputting the heat absorbing control signal to the thermoelectric semiconductor unit controller when the temperature detected by the temperature is equal to or higher than the predetermined value.

2. The device according to claim 1, wherein the thermoelectric semiconductor unit comprises:
thermoelectric semiconductor elements, which are connected to the thermoelectric semiconductor unit controller, and are configured to radiate heat when the input current flows in the first direction and to absorb heat when the input current flows in the second direction; and
heat radiating fins, which are configured such that first ends thereof are exposed in the battery tray and such that second ends are connected to the thermoelectric semiconductor elements, thus transmitting the heat, radiated by the thermoelectric semiconductor elements, to the battery tray, and absorbing the heat inside the battery tray so as to be transmitted to the thermoelectric semiconductor elements.

3. The device according to claim 1, further comprising a cooling fan that is located in an intake port or an exhaust port of the battery tray to radiate the heat inside the battery tray,
wherein the battery controller operates the cooling fan when a detection temperature of the temperature sensor is equal to or higher than the predetermined value.

4. The device according to claim 3, wherein the thermoelectric semiconductor unit is configured such that a portion thereof is located so as to be exposed in the exhaust port of the battery tray.

5. The device according to claim 1, further comprising a heater that is located in an intake port of the battery tray to supply heat to the battery tray,
wherein the battery controller operates the heater when a detection temperature of the temperature sensor is lower than the predetermined value.

6. The device according to claim 1, further comprising:
an auxiliary battery for supplying power to the thermoelectric semiconductor unit via the battery controller; and
a switch for controlling connection between the auxiliary battery and the battery controller.

7. The device according to claim 1, further comprising:
an inlet three-way valve, which is located in an intake port of the battery tray, and is configured to isolate air inside the battery tray from external air and to recirculate the air inside the battery tray;
an outlet three-way valve, which is located in an exhaust port of the battery tray, and is configured to isolate the air inside the battery tray from the external air and to recirculate the air inside the battery tray; and
a recirculation air pipe, which is configured such that one end thereof is connected to the inlet three-way valve and such that a remaining end thereof is connected to the outlet three-way valve, thus enabling the internal air to be recirculated by causing air, which is discharged from the exhaust port, to be provided to the intake port.

8. The device according to claim 1, further comprising a heat insulating material, which is mounted outside the battery tray to isolate air inside the battery tray from air outside the battery tray.
